(19) United States
(12) Patent Application Publication
(10) Pub. No.: US 2004/0016307 A1
(43) Pub. Date: Jan. 29, 2004

(54) Vibration isolation mechanism for a vibrating beam force sensor

(76) Inventor: William C. Albert, Lakewood, NJ (US)

Correspondence Address: NIXON & VANDERHYE P.C., 8th Floor, 1100 North Glebe Road, Arlington, VA, 22201, US

(21) Appl. No.: 10/201,280

(22) Filed: Jul. 24, 2002

(51) Int. Cl. G01L 1/10

(52) U.S. Cl. 73/862.627

(57) ABSTRACT

A force sensor apparatus includes a vibrating beam and first and second isolator mass members that supports ends of the vibrating beam. The first and second isolator mass members are configured symmetrically relative to an axis that intersects the vibrating beam at an angle other than 90 degrees. First and second end mounts connect respectively to the first and second isolator mass members. Each isolator mass member has a center of gravity. Each isolator mass member is shaped so that it can be massive (e.g., along the x-axis direction) while at the same time having its center of gravity at an optimal location so that undesirable beam forces and moments that would otherwise transfer vibrating beam energy to the end mounts are cancelled.

### FIELD OF THE INVENTION

The present invention relates to vibrating beam force sensors, and more particularly, to isolator mechanisms for isolating the vibrations of a vibrating member from its mounts to minimize coupling between the member and its mounts over a range of frequencies of vibration.

### BACKGROUND AND SUMMARY OF THE INVENTION

Vibrating beam force transducers find application in the instrumentation field in accelerometers, pressure transducers, scales, etc. In a vibrating beam force transducer, a vibratory beam member is supported so that axial forces to its ends change its axial stress in response to an input acceleration, pressure, etc. to be measured. In an axially unstressed condition, a beam has a particular natural frequency of vibration determined primarily by its dimensions, its material, its end conditions, and to a smaller extent the temperature and the media in which it is operating. As an applied force changes the axial tension or compression load on the beam, the beam's natural frequency of vibration changes. The frequency of its flexure vibration increases with axial tension and decreases with axial compression.

Frequency modulated vibratory sensors are attractive in instrumentation because of the inherent high resolution, digital nature of the output signal. When the sensor material is quartz crystal, the sensor has excellent stability of bias frequency and span as well as low temperature sensitivity. The piezoelectric property of quartz crystal provides a simple way of sustaining the vibration using an oscillator circuit electrically connected to electrodes plated on the crystal beam resonator.

Although it is desirable to have the vibration frequency output be a true and accurate representation of the actual force applied to the vibrating beam, this is not always the case. In practical applications, a vibrating beam force transducer is mounted to one or more end mounts. There is an energy loss at the mount interface because the mount resists the forces and moments generated by the vibrating beam resonator. This results in a decrease in the “Q” factor of the beam resonator, i.e., the ratio of peak energy to the energy lost per cycle of the vibrating beam resonator. In addition to decreased efficiency, a decrease in Q also degrades the frequency stability of the resonator. Thus, to achieve an efficient and stable vibrating beam resonator, it is desirable to design the transducer so that very little of the vibration energy is lost during operation.

FIG. 1 illustrates a known vibrating beam force transducer apparatus 10 with a vibration isolation mechanism. A pair of end mounts 12 and 14 are attached to isolation members 18 and 20 by way of corresponding pairs of thin spring members 22, 24, and 26, 28, respectively. Each isolation member and corresponding spring member is called an isolator mass structure. Axial forces are applied along an X-axis to one or both end mounts 12 and 14 when the apparatus 10 is used as a force measuring unit such as in an accelerometer application. A vibrating beam 16 extends between the two isolation members 18 and 20. The vibrating beam 16 is isolated from the mounts 12 and 14 at beam operating frequencies by the isolation members 18 and 20 as well as the thin spring members 22-28. Axial stresses, either tension or compression, applied to the end mounts 12 and 14 are transported to the beam 16 through the thin spring members 22, 24, 26, and 28 and isolator members 18 and 20.

Electrodes are used to drive the beam 16 so that it vibrates at a particular frequency. One pair of electrodes 38 and 40 is attached to opposite sides of the beam 16 along one axial extent, and another pair of electrodes 42 and 44 is attached to opposite sides of the beam along another axial extent. An oscillator circuit (not shown) provides driving excitation for the beam 16. The oscillator circuit applies oppositely-directed, transverse electric fields at axially-spaced locations to vibrate the beam. This arrangement is a shear mode piezoelectric drive known in the art.

The vibrating beam 16 in a momentary posture shown in FIG. 2 depicts the force-frequency effect of a vibrating flexure beam. The deflection is exaggerated for better illustration. The variable L corresponds to the length of the beam, t represents the thickness of the beam, b represents the width of the beam, and F represents the axial force on the beam.

In the exploded drawing shown in FIG. 3, the various reactions to the beam 16 vibrating with amplitude Y_{B} are represented by reactive forces F_{1Y}, F_{1X} and V and the reactive moment M. The V and M reactions are by far the largest. Also, because the vibration frequency of the beam 16 is much greater than the natural frequency of the isolation mechanism to both Y_{R} linear and A angular vibration modes, the phasing of the various linear and angular displacements is as shown in FIG. 3. When the beam is deflected at its root locations intermediate to its ends, there is a reaction force V and reaction moment M in the directions indicated by the arrows. The reaction force V is directed oppositely to the beam's primary Y_{R} deflection, and the reaction moment M tends to twist the ends of the beam about a Z-axis perpendicular to the paper to oppose the bending deflection. The forces and moments applied by the beam into the supports vary depending on amplitude and frequency of the beam's vibration and on the beam's size. Because the forces and moments applied by the beam tend to shake the mounts to which they are secured, some of the beam's vibrating energy is lost. The isolation mass structure in FIG. 1 attempts to isolate the vibrating beam from the end mounts in an effort to attenuate the reaction forces and reaction moments.

The vibration mode of the vibrating beam in FIG. 3 is that of a virtual-fixed vibrating beam. The term “virtual” is used in the sense that at the beam roots there is a slight Y-axis displacement (Y_{R}) and a slight angular displacement about the Z-axis as indicated by angle A. Y_{R} is on the order of one percent of the positive Y-axis displacement from the neutral center line Y_{R} of the maximum beam in deflection. The angle A can vary but is generally on the order of ±1% of the point of maximum vibrating beam slope.

The bending moment M and shear force V reactions at the beam root are the primary reactions of the system. Because the spring members 22-28 are long and thin, and therefore flexible for Y displacement, the F_{1Y} reactions are very small but not completely negligible. However, because these beams are axially stiff, the F_{1X} reactions, while small compared to the shear force v and the bending moment M reactions, are not negligible and are a primary cause of energy loss through the end mounts.

A net F_{1X} may result from the F_{1X} forces of the two isolator members 18, 20 being opposite but unequal. In addition, a net moment reaction may result from a moment reaction due to the F_{1X} forces acting in different directions. These net forces or moment reactions are transferred through the isolator members 18, 20 to the mounts structure resulting in energy loss and reduced Q. However, both the net F_{1X} and the moment effects may be reduced if the axial Y_{R} displacement and the angular A displacement can be reduced.

FIG. 4 is a simplified version of FIG. 3 which considers just the major moment M and shear force V reactions transferred to the isolator mass structure center of gravity (CG) using the well-known parallel axis theorem. Even though the FIX reactions are present and are the major cause of energy loss, they are small compared to the M and V reactions, and therefore, are omitted from FIG. 4 to simplify the drawing and analysis. For this simplified situation, the isolator member reaction to the moment M and shear force V reactions is purely inertial, and the Y_{R} and A displacements can be closely approximated by equations (1) and (2) set forth below:

$$\begin{matrix}{Y}_{R} \approx \frac{- V}{{{m}_{I} ( 2 π f )}^{2}} and & ( 1 ) \\ A \approx \frac{( M - Vd )}{{m}_{l} {{k}^{2} ( 2 π f )}^{2}} & ( 2 )\end{matrix}$$

where Y_{R} is the vertical displacement of the beam root and therefore the isolator mass CG from the neutral center line shown in FIG. 3, V is the shear force, m₁ is the mass of the isolation system (corresponding to the two isolator mass structures), ƒ is the vibration frequency of the beam, M is the bending moment, d is the distance between the isolator mass structure center of gravity and the vertical support member of the isolator mass structure, and k is the radius of gyration of the isolator mass structure. Approximation signs are used instead of equal signs because of the simplifying assumptions used as described above.

The mass of the isolator structure m₁ appears in the denominator in both equations (1) and (2), which indicates that both Y_{R} and A are inversely proportional to the mass of the isolator structure. As a result, the greater the mass of the isolator mass structure, the smaller the displacements Y_{R} and A which results in greater effectiveness of the isolation mechanism and a higher Q for the vibrating beam force transducer.

Furthermore, equation (2) indicates that the angular displacement A can be reduced to zero if M equals Vd, hereafter referred to as the “tuned condition.” In the tuned condition, the angle displacement A, and hence the F_{1X} reactions, approach zero. For a fixed vibrating beam, flexure theory predicts a fixed relationship between M and v such that the condition M=Vd can be brought about if d=0.215 L_{B}, where L_{B} is the length of the vibrating beam. Proper proportioning of the isolator members should be used to locate the center of gravity of each isolator mass structure to a tuned condition position that cancels the moment M. Unfortunately, the vibration isolator design shown in FIG. 1 does not permit a massive isolator mass that can operate at an optimal tuned condition.

It is an object of the present invention to provide an effective vibration isolator design that minimizes the amount of energy transferred from a vibrating beam to a mount structure.

It is an object of the present invention to provide an effective vibration isolator design that minimizes at the vibrating beam roots Y-axis displacement (Y_{R}) and angular displacement (angle A) about the Z-axis.

It is an object of the present invention to provide a vibration isolator design with a massive isolator mass structure shaped and proportioned so that a tuned condition operation may also be achieved.

It is an object of the present invention to provide a vibrating beam force sensor apparatus in which isolator mass structures are skew-symmetric with respect to the horizontal vibrating beam to permit more massive isolator structures with centers of gravity located to achieve an optimal tuning condition.

The force sensor apparatus includes a vibrating beam and first and second isolator mass members that support the ends of the vibrating beam. The first and second isolator mass members are configured symmetrically relative to an axis that intersects the vibrating beam at an angle other than 90 degrees. First and second end mounts connect respectively to the first and second isolator members. Each isolator mass member has a center of gravity. Each isolator mass member is shaped so that it can be massive (e.g., along the x-axis direction) while at the same time having its center of gravity at an optimal location so that undesirable beam forces and moments that would otherwise transfer vibrating beam energy to the end mounts are cancelled.

In a preferred example embodiment, each isolator mass member is L-shaped. One example L-shape includes first and second perpendicular portions with the second arm portion extending perpendicular to the first portion and parallel to the vibrating beam. The first and second portions of each isolator mass member are sized such that a distance between the center of gravity and the closest edge of the first portion corresponds to a condition where little or no energy from the vibrating beam is transferred to the corresponding end mount. In a preferred example embodiment, that distance is approximately 0.215 multiplied times the distance between the closest edges of the first portions of the two isolator mass members. A thickness of the first portion and a length of the second portion of each isolator mass may be increased to increase the mass of the isolator while still maintaining the center of gravity for each isolator mass member at the location for optimal “tuned” operation.

In another example embodiment, another example L-shape includes a third arm portion, considerably shorter than the second portion, that also extends perpendicular to the first portion and parallel to the vibrating beam. Because the third portion is relatively short compared to the second portion, the optimal location of the center of gravity and the increased massiveness of the isolator mass are preserved. Other shapes may be employed as long as there is “skewed” symmetry that allows increased isolator member massiveness while preserving its center of gravity at an optimum, tuned location.

In the context of a force sensor, electrodes are provided to stimulate the vibrating beam into vibration and for monitoring the frequency of vibration related to a direction and an amount of force applied to the force sensor apparatus. Such a force sensor finds example application as a pressure sensor, an accelerometer, as part of a scale, or any other force sensing environment.

### BRIEF DESCRIPTION OF THE DRAWINGS

The foregoing and other objects, features, and advantages of the present invention may be more readily understood with reference to the following description taken in conjunction with the accompanying drawings where like reference numbers refer to like elements.

FIG. 1 illustrates a beam force transducer with integral mounting isolation;

FIG. 2 illustrates the force-frequency effect of a vibrating flexor beam;

FIG. 3 illustrates an exploded view of the beam structure of FIG. 1 in flexure;

FIG. 4 illustrates a simplified drawing of the isolator mass structure;

FIG. 5 illustrates an isolator mass structure in accordance with one example embodiment of the invention;

FIG. 6 illustrates an isolator mass structure in accordance with another example embodiment of the invention; and

FIG. 7A is a top view while FIG. 7B is a side view of a pressure sensor assembly incorporating the isolator mass structure of FIG. 5.

### DETAILED DESCRIPTION

In the following description, for purposes of explanation and not limitation, specific details are set forth, such as particular embodiments, techniques, etc. in order to provide a thorough understanding of the present invention. However, it will be apparent to one skilled in the art that the present invention may be practiced in other embodiments that depart from these specific details. In some instances, detailed descriptions of well-known methods, devices, and techniques are omitted so as not to obscure the description of the present invention with unnecessary detail.

The present invention may be used in any vibratory beam apparatus. While the vibrating beam apparatus may be formed from any single material, it is preferred that the apparatus be made of a single block of quartz crystal or other piezoelectric material. While the preferred material is quartz crystal, other metallic or non-metallic material can be used. If these materials are not piezoelectric, an alternate vibrating drive mechanism would be used. Example applications of the present invention are in the context of accelerometers, pressure sensors, scales, etc. The invention may be used in other force sensing applications as well.

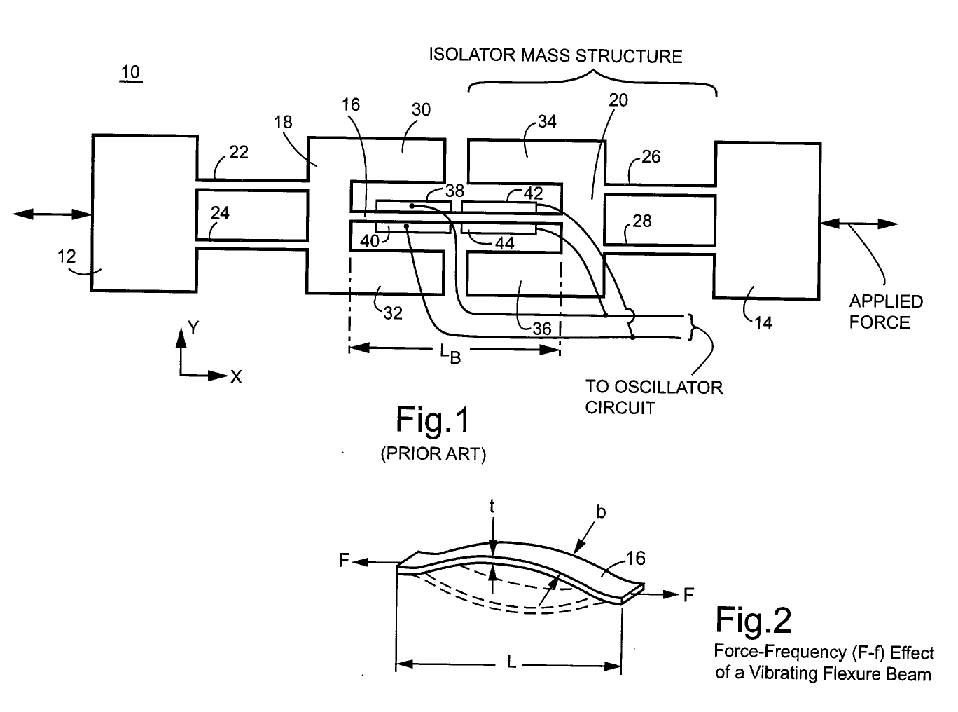

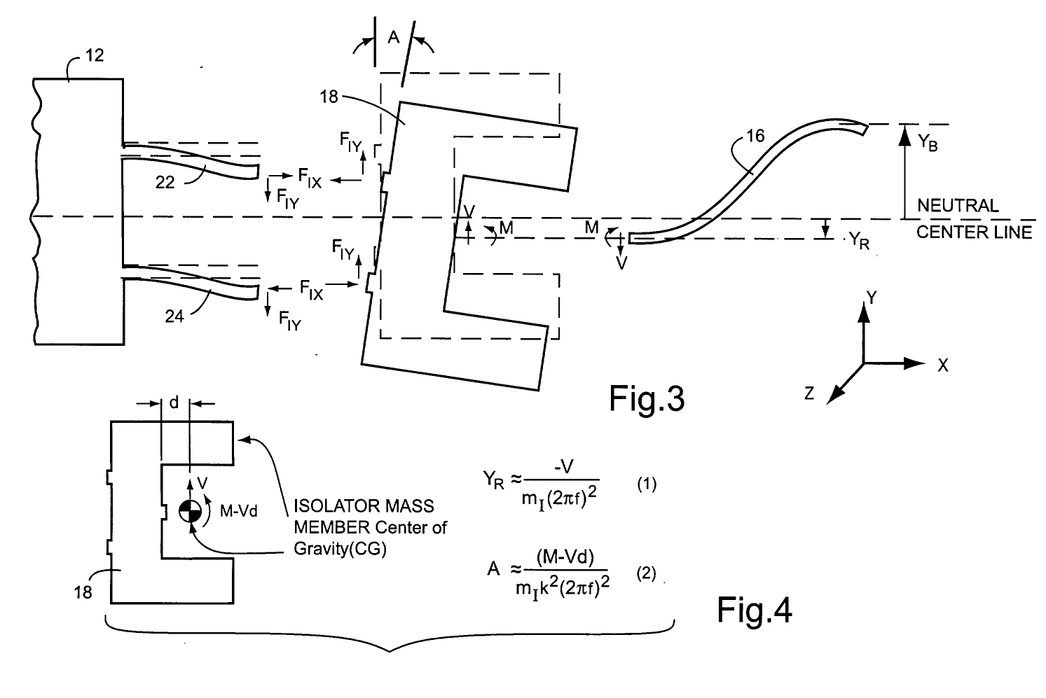

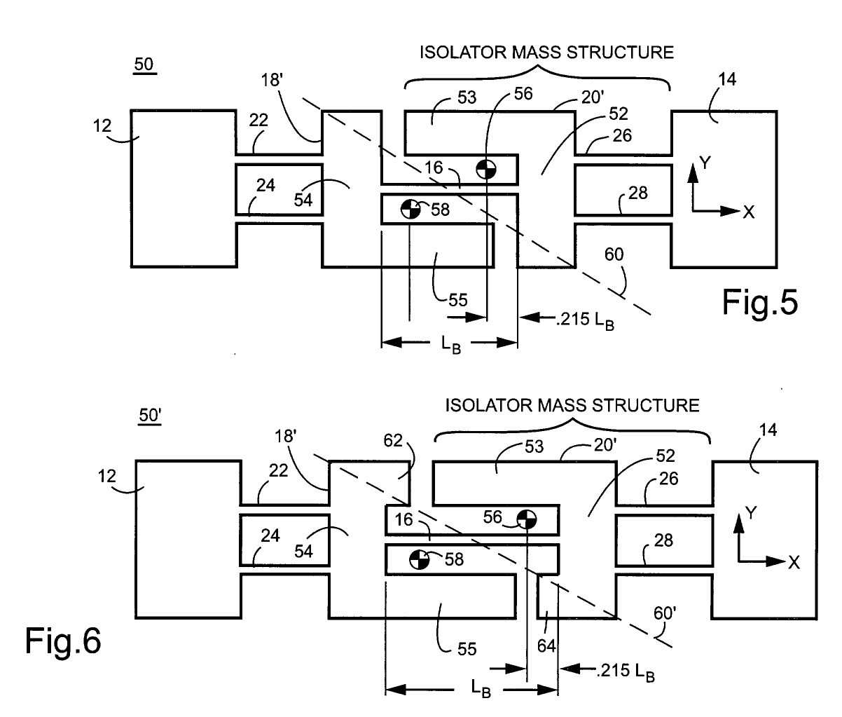

FIG. 5 illustrates a vibrating beam apparatus 50 in accordance with an example embodiment of the present invention. The vibrating beam apparatus 50 includes some structures similar to those described in FIG. 1 including end mounts 12 and 14, a vibrating beam 16, isolator members 18 and 20, coupled to respective ones of the end mounts by corresponding thin spring members 22, 24, 26, and 28. The electrodes on the surface of the vibrating beam 16 and wires to an oscillator drive circuitry are not shown to simplify the drawing. However, the isolator members are indicated as 18′, 20′ because they are shaped and sized differently from the members 18 and 20 shown in FIG. 1.

In the isolator mass design shown in FIG. 1, the isolator members are symmetric relative to plural axes parallel to the y-axis and perpendicular to the y-axis. In FIG. 5, the isolator members 18′, 20′ are symmetric in a “skewed” fashion relative to an axis that intersects the vibrating beam (parallel to the x-axis) at an angle other than 90 degrees. The term “skewed” means slanted or the like, and one can view the isolator members 18′, 20′ as “skew-symmetric” or symmetric relative to a slanted line.

In the example embodiment of FIG. 5, each isolator member 18′, 20′ includes an extended isolator mass arm. Isolator member 18′ includes a vertical base portion 54 and a horizontal arm portion 55 in a first configuration. Isolation member 20′ includes a vertical base portion 52 and a horizontal arm portion 53 in a second configuration. The first and second configurations of the isolation members 18′, 20′ are symmetric with respect to the slanted axis 60 that intersects the beam 16 at an angle other than 90 degrees. The skew-symmetric design allows for the base portions 54 and 52 to be relatively thick in the X direction to increase the mass of each isolator member 18′ and 20′. At the same time, the skew-symmetric design also allows each of the horizontal arm portions 55 and 53 to extend far over the vibrating beam 16 in opposing parallel planes to counter the increased mass of the thicker base portions 54 and 52. The extended arm portions 55 and 53 maintain the centers of gravity 58 and 56 of the isolator mass structures for each of the isolation members 18′ and 20′ at the optimum position for tuned condition operation.

Using the skew-symmetric design, the mass m₁ of each isolator member in equations (1) and (2) can be increased substantially. From those equations, an increase in the mass of the isolator mass members decreases the axial and angular displacements Y_{R} and A resulting in greater effectiveness of the isolation mechanism and a higher Q for the vibrating beam force transducer. Because the arm portions overhang the beam 16 to a considerable extent, each isolation member can be designed so that the moment M equals the shear force V times the distance “d” in the X direction between the center of gravity 56 and 58 of the isolator mass structures and the point where the beam 16 connects to each of the isolator members 18′, 20′. The optimum distance d to achieve the tuned condition, i.e., M=Vd, is when d=0.²¹⁵L_{B}, where L_{B} is the length of the vibrating beam 16. Operating at the tuned condition reduces the angular displacement A to theoretically zero. Making the vertical base portions thicker in the X direction moves the center of gravity for each of the isolator members closer to the base portion reducing d to a value less than the optimum 0.215 L_{B}. However, by extending the horizontal arms 55 and 53 in the X direction, the center of gravity for the isolator mass structures for each of the isolator members 18′ and 20′ is moved in the opposite direction, thereby maintaining the distance d at the tuned condition of 0.215 L_{B}.

FIG. 6 illustrates another example skew-symmetric design for a vibrating beam apparatus 50 that is similar in most respects to the design shown in FIG. 5. However, the isolator mass members 18′, 20′ each include a third arm portion 62 and 64, respectively, that extend perpendicularly from their respective base portions 54 and 52 for a short distance in a plane parallel to the vibrating beam 16 and to their respective second arm portions 55 and 53. The isolator mass members 18′, 20′ are symmetric about a skewed line 60′ and permit, in similar manner to the design in FIG. 5, increased isolator member massiveness while still preserving the optimum, tuned condition location of the centers of gravity 58 and 56. Other skew-symmetric designs may be employed with similar benefits.

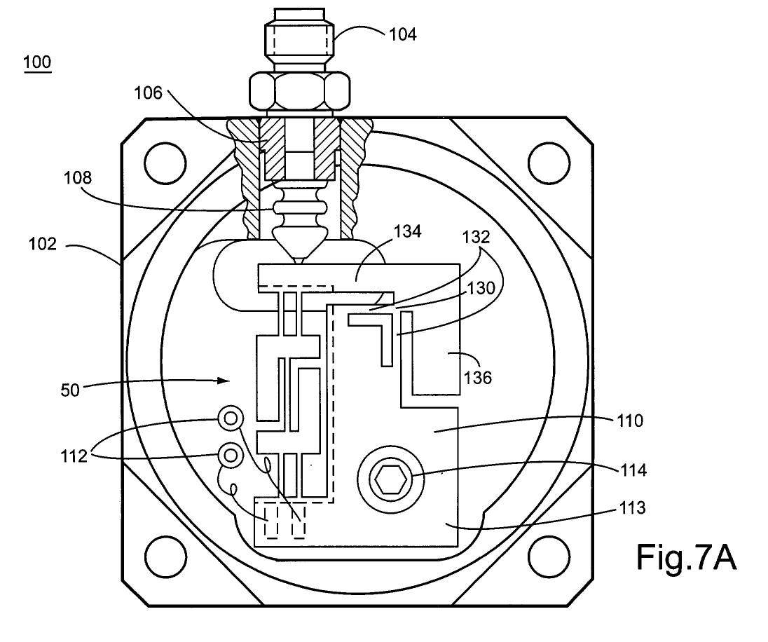

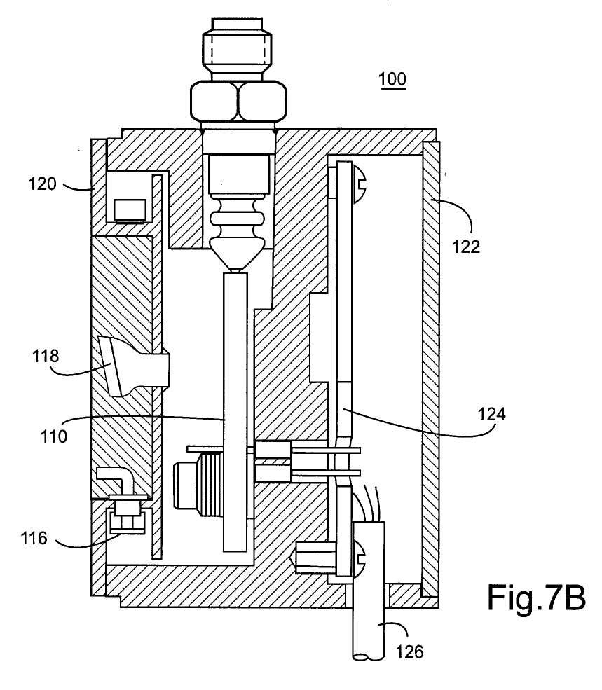

FIGS. 7A and 7B illustrate an example application of the vibrating beam force sensor 50 shown in FIG. 5 in the context of a pressure sensor located generally at 100. FIG. 7A includes a top view and FIG. 7B a side view of the pressure sensor 100. A skew-symmetric vibrating beam force sensor 50 is coupled to and is a part of a crystal resonator 110 secured by a mount screw 114 to a sensor housing 102. The crystal resonator 110 is enclosed and evacuated in sealed housing. Locating the structure in an evacuated housing avoids air resistance which would otherwise dampen vibrations and reduce the Q of the vibrating beam of sensor 50. The crystal cavity is sealed using a top cover 110 and a bottom cover 122 by braising, welding, soldering, or the like. A getter 116 is included in the crystal cavity to maintain vacuum quality. Evacuation is achieved by way of an exhaust tube 118. Electrical feed-throughs 112 are provided for wires to connect beam electrodes plated on the resonator to an oscillator circuit board 124 shown in FIG. 7B. Pulses from the oscillator 124 to the electrodes cause the beam to vibrate at a particular frequency.

A bellows 108 is made of electrode-deposited nickel with a thin wall thickness for very low spring rate. The conical termination of the bellows 108 forms a well-defined contact point where it meets one of the end mounts 134 of the crystal resonator 110. The bellows 108 is coupled at its other end to a fitting 104 inserted into the housing 102 via a hub 106. Orthogonal flexure beams 132 permit the end mount 134 and a balance weight 136 to rotate about pivot point 130 under the influence of pressure to the bellows 108. The bellows 108 converts fluid pressure to a force acting upon the end mount 134. The force is caused by a pressure difference between fluid inside and outside of the bellows 106. Movement about the pivot point 130 is resisted by the vibrating beam experiencing a compression force which changes the resonant vibrating frequency of the vibrating beam. The change of frequency is thereby a measure of the fluid pressure.

While the present invention has been described with respect to particular embodiments, those skilled in the art will recognize that the present invention is not limited to these specific exemplary embodiments. Different embodiments and adaptations besides those shown and described as well as many variations, modifications, and equivalent arrangements may also be used to implement the invention. Therefore, while the present invention has been described in relation to its preferred embodiments, it is to be understood that this disclosure is only illustrative and exemplary of the present invention. Accordingly, it is intended that the invention be limited only by the scope of the claims appended hereto.

What is claimed is:

1. A force sensor apparatus, comprising:
a beam capable of vibration;
a first L-shaped member in a first configuration supporting one end of the beam and to a first end mount by way of a first spring member; and
a second L-shaped member in a second, different configuration supporting the other end of the beam and to a second end mount by way of a second spring member,
wherein the first and second configurations are symmetric about an axis that intersects the beam at an angle other than 90 degrees.

2. The force sensor apparatus in claim 1, wherein the first L-shaped member is associated with a first center of gravity and the second L-shaped member is associated with a second center of gravity.

3. The force sensor apparatus in claim 2, wherein the first L-shaped member and the second L-shaped member each include a first portion to which the beam is connected and a second portion that extends perpendicular to the first portion and parallel to the beam.

4. The force sensor apparatus in claim 3, wherein the first and second portions of the first L-shaped member are sized so that a first distance between the first center of gravity and a closest edge of that first portion corresponds to a condition where little or no energy from the vibrating beam is transferred to the first end mount, and
wherein the first and second portions of the second L-shaped member are sized so that a second distance between the second center of gravity and a closest edge of that first portion corresponds to a condition where little or no energy from the vibrating beam is transferred to the second end mount.

5. The force sensor apparatus in claim 4, wherein the first and second distances are each approximately 0.215 multiplied times a distance between the closest edges of the first portions.

6. The force sensor apparatus in claim 4, wherein a thickness of the first portion and a length of the second portion of the first L-shaped member are increased to increase the mass of the first L-shaped member and to maintain the first distance, and
wherein a thickness of the first portion and a length of the second portion of the second L-shaped member are increased to increase the mass of the second L-shaped member and to maintain the second distance.

7. The force sensor apparatus in claim 3, wherein in the first L-shaped member and the second L-shaped member each include a third portion considerably shorter than the second portion that extends perpendicular to the first portion and parallel to the vibrating beam.

8. The force sensor apparatus in claim 7, wherein the first, second, and third portions of the first L-shaped member are sized so that a first distance between the first center of gravity and a closest edge of that first portion corresponds to a condition where little or no energy from the vibrating beam is transferred to the first end mount, and
wherein the first, second, and third portions of the second L-shaped member are sized so that a second distance between the second center of gravity and a closest edge of that first portion corresponds to a condition where little or no energy from the vibrating beam is transferred to the second end mount.

9. The force sensor apparatus in claim 1, wherein the first L-shaped member is connected to the first end mount by way of two parallel thin spring members, and the second L-shaped member is connected to the second end mount by way of two parallel thin spring members.

10. The force sensor apparatus in claim 1, further comprising:
electrodes for stimulating the beam into vibration for monitoring a frequency of vibration which is related to a direction and amount of force applied to the force sensor apparatus.

11. The force sensor apparatus in claim 1, wherein the force sensor apparatus is a pressure sensor apparatus.

12. The force sensor apparatus in claim 1, wherein the force sensor apparatus is an accelerometer sensor apparatus.

13. A force sensor apparatus comprising:
a beam capable of vibration;
first and second isolator masses supporting the beam, each isolator mass having a first end and a second end;
first and second mounts connected respectively to the first and second isolator masses;
a single first isolator beam extending perpendicularly from the first end of the first isolator mass toward the second isolator mass in a first plane; and
a single second isolator beam extending perpendicularly from the second end of the second isolator mass toward the first isolator mass in a second plane different from but parallel to the first plane.

14. The force sensor apparatus in claim 13, wherein the first isolator mass and first isolator beam form an L-shape, and the second isolator mass and second isolator beam form an L-shape.

15. The force sensor apparatus in claim 13, wherein the first isolator mass and beam includes a first center of gravity and the second isolator mass and beam includes a second center of gravity.

16. The force sensor apparatus in claim 15, wherein the first isolator mass and beam are sized so that a first distance between the first center of gravity and a closest edge of that first isolator mass corresponds to a condition where little or no energy from the vibrating beam is transferred to the first end mount, and
wherein the second isolator mass and beam are sized so that a second distance between the second center of gravity and a closest edge of that second isolator mass corresponds to a condition where little or no energy from the vibrating beam is transferred to the second end mount.

17. The force sensor apparatus in claim 16, wherein the first and second distances are each approximately 0.215 multiplied times a distance between the closest edges of the first and second isolator masses.

18. The force sensor apparatus in claim 16, wherein a thickness of the first isolator mass is increased to increase its mass and a length of the first isolator mass beam is increased to maintain the first distance, and
wherein a thickness of the second isolator mass is increased to increase its mass and a length of the second isolator mass beam is increased to maintain the second distance.

19. The force sensor apparatus in claim 13, wherein the first and second isolator mass and beam configuration are symmetric about an axis that intersects the vibrating beam at an angle other than 90 degrees.

20. The force sensor apparatus in claim 13, wherein the force sensor apparatus is a pressure sensor apparatus.

21. The force sensor apparatus in claim 13, wherein the force sensor apparatus is an accelerometer sensor apparatus.

22. A force sensor apparatus comprising:
a beam capable of vibration;
first and second, similarly-shaped, isolator masses supporting the beam and configured symmetrically relative to an axis that intersects the beam at an angle other than 90 degrees; and
first and second end mounts connected respectively to the first and second isolator masses.

23. The force sensor apparatus in claim 22, wherein the first isolator mass is associated with a first center of gravity and the second isolator mass is associated with a second center of gravity.

24. The force sensor apparatus in claim 23, wherein the first and second isolator masses are L-shaped.

25. The force sensor apparatus in claim 23, wherein the first and second isolator masses each include a first portion to which the beam is connected and a second portion that extends perpendicular to the first portion and parallel to the beam.

26. The force sensor apparatus in claim 25, wherein the first and second portions of the first isolator mass are sized so that a first distance between the first center of gravity and a closest edge of that first portion corresponds to a condition where little or no energy from the vibrating beam is transferred to the first end mount, and
wherein the first and second portions of the second isolator mass are sized so that a second distance between the second center of gravity and a closest edge of that first portion corresponds to a condition where little or no energy from the vibrating beam is transferred to the second end mount.

27. The force sensor apparatus in claim 26, wherein the first and second distances are each approximately 0.215 multiplied times a distance between the closest edges of the first portions.

28. The force sensor apparatus in claim 26, wherein a thickness of the first portion and a length of the second portion of the first isolator mass are increased to increase the mass of the first isolator mass and to maintain the first distance, and
wherein a thickness of the first portion and a length of the second portion of the second isolator mass are increased to increase the mass of the second isolator mass and to maintain the second distance.

29. The force sensor apparatus in claim 23, wherein in the first isolator mass and the second isolator mass each include a third portion considerably shorter than the second portion that extends perpendicular to the first portion and parallel to the beam.

30. The force sensor apparatus in claim 29, wherein the first, second, and third portions of the first isolator mass are sized so that a first distance between the first center of gravity and a closest edge of that first portion corresponds to a condition where little or no energy from the vibrating beam is transferred to the first end mount, and
wherein the first, second, and third portions of the second isolator mass are sized so that a second distance between the second center of gravity and a closest edge of that first portion corresponds to a condition where little or no energy from the vibrating beam is transferred to the second end mount.

31. The force sensor apparatus in claim 23, further comprising:
electrodes for stimulating the beam into vibration for monitoring a frequency of vibration which is related to a direction and amount of force applied to the force sensor apparatus.

32. The force sensor apparatus in claim 23, wherein the force sensor apparatus is a pressure sensor apparatus.

33. The force sensor apparatus in claim 24, wherein the force sensor apparatus is an accelerometer sensor apparatus.
